(19) United States
(12) Patent Application Publication
(10) Pub. No.: US 2025/0102352 A1
(43) Pub. Date: Mar. 27, 2025

(54) MONOLITHIC OPTICAL PRESSURE SENSORS AND TRANSDUCERS

(71) Applicants: Raymond DeCorby, Edmonton (CA); Graham Hornig, Edmonton (CA)

(72) Inventors: Raymond DeCorby, Edmonton (CA); Graham Hornig, Edmonton (CA)

(21) Appl. No.: 18/730,429

(22) PCT Filed: Jul. 29, 2022
(86) PCT No.: PCT/CA2022/051164

§ 371 Date: Jul. 19, 2024

Related U.S. Application Data
(60) Provisional application No. 63/301,595, filed on Jan. 21, 2022.

(51) Int. Cl. G01H 9/00

(52) U.S. Cl. CPC G01H 9/00

(57) ABSTRACT

The present invention provides for novel devices for the detection of acoustic or ultrasonic signals within a fluid by way of selective delaminating of portions of a multiplicity of laminar films, the laminar films providing high reflectance over select wavelengths and optical transparency to others, wherein delamination results in the creation of optically resonant chambers which when interrogated with EM radiation may be used to provide highly sensitive detection of the acoustic or ultrasonic signals.

### CROSS-REFERENCE TO RELATED APPLICATIONS

The present application claims priority from U.S. provisional patent application No. 63/301,595 filed Jan. 21, 2022, such application is expressly incorporated by reference herein for all purposes.

### FIELD OF THE INVENTION

The present invention pertains to the field of pressure sensors, ultrasound detection and generation of ultrasonic waves.

### BACKGROUND OF THE INVENTION

All of the publications, patents and patent applications cited within this application are herein incorporated by reference in their entirety to the same extent as if the disclosure of each individual publication, patent application or patent was specifically and individually indicated to be incorporated by reference in its entirety.

Buckling delamination of thin films is a fairly well understood phenomenon. Within the regime of elastic deformation, the buckled areas are characterized by an increase in bending strain energy but a decrease in compressive strain energy. Buckling of a film can occur spontaneously, provided: (i) the compressive energy exceeds the bending energy for a given buckled width, and (ii) the energy release rate (per unit area under the buckle) is higher than the adhesion energy per unit area between the film (or stack of films) and its substrate. Since film delamination causes catastrophic failure of microelectronic circuits or of protective barrier coatings, buckling has traditionally been studied as a problem to be avoided. To control the location and shape of delamination buckles, two distinct properties may be engineered: a technique for creating regions of low and high adhesion is required, and means for accurately controlling the stress within the layers to be buckled. On a laminar assembly of materials, by varying the deposition parameters, the magnitude of compressive stress for many standard thin film dielectrics can be controlled with high accuracy. U.S. Pat. No. 8,503,849 teaches an example of using this delamination and buckling process to provide for embodiments, including a guided self-assembly of straight-sided, Euler-like buckles by delamination of a multilayer stack.

Optical pressure sensors have well-known attributes such as immunity to electromagnetic interference (EMI) and potential for operation in harsh environments. Diaphragm-based extrinsic Fabry-Perot interferometers (DEFPI) have been amongst the most popular types. In the DEFPI, a flexible membrane is configured as one mirror in a typically low-finesse, planar Fabry-Perot structure, separated from the second ‘mirror’ (often a simple optical interface such as the cleaved end facet of an optical fiber) by a sealed and ‘empty’ (typically air) cavity. Changes in external pressure deflect the membrane and modify the interference spectrum, thereby enabling optical detection. Most DEFPI work has targeted high-sensitivity, low-pressure and acoustic wave applications, although high-pressure sensors have also been achieved. The thickness, material stiffness (i.e., Young's modulus), and diameter of the membrane correlate directly with the pressure sensitivity, operating range, and maximum frequency response of the device. Thus, a wide variety of membrane materials have been studied, ranging from graphene to stainless steel, amongst many others. Most are fabricated using some combination of surface- and bulk-micromachining, involving a membrane bonding (and sometimes thinning) step that seals the space between the membrane and the second optical interface. These tend to be relatively complex and time-consuming serial processes.

Nearly all reported DEFPI devices are planar structures with relatively low finesse. Planar Fabry-Perot Interferometers are marginally unstable as optical resonators, and are thus subject to various finesse-reducing non-idealities, particularly when illuminated by non-collimated light from Gaussian laser beams or fiber modes. Accordingly, sensing is typically carried out by monitoring the shift of spectrally broad, nearly periodic Fabry-Perot fringes, which limits the detection sensitivity and/or necessitates the use of relatively complex signal processing algorithms. There have been some efforts towards implementing higher-finesse planar-cavity-based pressure sensors, but their performance is ultimately limited by the factors mentioned above.

It is well known that the detection limit (i.e., the minimum resolvable shift in some measurand) for optical cavity sensors typically scales with the linewidth of the resonance, or inversely with the quality (Q) factor. From a simplistic point of view, the minimum resolvable shift in resonant wavelength (Δλₘᵢₙ) can be approximated by the linewidth (δλ); i.e. Δλₘᵢₙ˜δλ. A more detailed treatment needs to consider various noise sources, but predicts similar trends. For example, White and Fan estimated that s˜δλ (4.5·SNR^{0.25}), where s is the standard deviation (i.e. uncertainty) in the estimation of a resonant wavelength, δλ=λ/Q, and SNR is the overall signal-to-noise ratio of the detection system in linear units. These relationships and trends hold over a wide range of practical Q-factors, and have motivated the use of high-Q microcavities for refractive-index-based sensors.

High-frequency acoustic (ultrasound) signals are widely used for medical imaging and non-destructive testing (NDT). Piezoelectric sensors and transducers have long been the dominant commercial technology for these applications. However, the sensitivity of piezoelectric devices scales inversely with size, which creates challenges for high-resolution imaging, especially at high acoustic frequencies, which has spurred efforts to develop alternative technologies.

Optical detectors for ultrasound can deliver high sensitivity in a small footprint, and are currently the subject of an intensive research effort. These devices can be categorized approximately as devices in which the refractive index of a medium is modulated (e.g. through photoelastic effects, etc.) by an incident pressure wave, and devices in which the motion of some part (e.g. a suspended membrane) is modulated by an incident pressure wave. In many cases, pressure simultaneously modulates both the refractive index and the physical dimensions, the combination producing an effective change in the optical path length.

Most proposed optical ultrasound detectors employ optically resonant structures (e.g. ring resonators or photonic crystal microcavities) as a means to enhance readout sensitivity. Historically, the planar Fabry-Perot (FP) etalon has played a central role, although it suffers from well-known drawbacks (e.g. limited finesse arising from beam walk-off) due to the lack of 3-dimensional light confinement. Guggenheim et al. (Guggenheim, J. A et al. (2017) Nature Photon 11:714-719) reported spherical-mirror Fabry-Perot resonators which sense ultrasound signals through photoelastic effects in a relatively thick polymer cavity layer. They achieved NEPs as low as ˜1.6 mPa/Hz^{1/2} and bandwidths as high as 40 MHZ, although with attendant trade-offs between these parameters.

When a moving part is used to detect pressure signals, the sensor can be viewed as an optomechanical device. Cavity optomechanical devices combine resonant optical structures, such as Fabry-Perot or waveguide ring resonators, with resonant mechanical structures, such as a vibrating membrane or cantilever. In a cavity optomechanical sensor, the optical resonance is exploited to enhance the detection sensitivity while the mechanical resonance is exploited to enhance the response to force, pressure, etc. The combination can enable sensitivity at the fundamental limits set by shot and thermal displacement noise. While many low-frequency optical pressure sensors employ a flexible membrane as part of a low-finesse planar FP cavity, the performance at ultrasound frequencies has often been hampered by the sub-optimal mechanical and optical quality of the devices.

Recently, cavity optomechanical sensors implemented in a silicon photonics platform have achieved impressive milestones for ultrasound detection. Westerveld et al. (Westerveld, W. J. et al (2011) Nature Photon 15:341-345) reported NEP as low as ˜1.3 mPa/Hz^{1/2} in water over an acoustical frequency range 3-30 MHZ, using a 20 μm diameter membrane to modulate the effective index of a silicon waveguide ring resonator. Using microdisk resonators, Basiri-Esfahani et al. (Basiri-Esfahani, A. et al (2019) Nat Commun 10:132) reported NEPs as low as 0.008-0.3 mPA/Hz^{1/2} for detection (in air) of ultrasound frequencies up to 1 MHz. However, the devices cited have typically required relatively complex fabrication processes and/or inefficient and inconvenient optical coupling, involving tapered nanofibers or grating couplers. Moreover, some of them are not easily implemented as 2-dimensional sensor arrays.

The present art is in need of improved pressure detectors, capable of detecting ultrasonic pressures, as well as capable of providing ultrasonic emissions.

### SUMMARY OF THE INVENTION

In one aspect the present invention provides for a method of forming a pressure sensitive optical resonant cavity and mechanical resonator comprising forming a multilayer stack of thin films, wherein the multilayer stack of thin films provides high reflectance over some wavelength ranges of interest and is transparent over some other wavelength ranges of interest and wherein the multilayer stack of thin films acts as a barrier for fluids; embedding a patterned low-adhesion surface or layer between at least two layers within the multilayer stack of thin films; forming an evacuated or partially evacuated, enclosed optical cavity within the multilayer stack of thin films by causing delamination and buckling to occur in the regions of the patterned low-adhesion surface or layer; and wherein the buckled portion of the multilayer stack of thin films functions as a flexible membrane and mechanical resonator. In one embodiment, the optical resonance properties of the cavity are adjusted by altering the in-plane strain of the buckled portion of the multilayer. In a further embodiment changes in the in-plane strain are induced by selective absorption of light within one or more layers. In further embodiment changes in the in-plane strain are induced by direct heating or cooling, such as by passing current through resistive heater electrodes. In further embodiment changes in the in-plane strain are induced by applying voltage or current to one or more piezo-electric layers.

In one embodiment the low adhesion surface or layer is a fluorocarbon layer. In an alternative embodiment the low adhesion surface or layer is a self-assembled monolayer. In another embodiment delamination and buckling occur spontaneously upon deposition of the multilayer stack of thin layers. In another embodiment delamination and buckling occur through the application of mechanical vibrational energy. In another embodiment delamination and buckling occur through the introduction of a thermal cycling process. In another embodiment circular patterns are created in the low-adhesion surface or layer, such that half-symmetric or plano-concave optical resonant cavities are formed. In another embodiment a temporal modulation of the in-plane strain of the buckled portion of the multilayer induces a vibrational mechanical oscillation.

In another aspect, the present invention provides for a method for forming a multiplicity of sealed and non-sealed cavity optomechanical devices on a single wafer, comprising forming a multilayer stack of thin films, wherein the multilayer stack of thin films provides high reflectance over some wavelength ranges of interest and is transparent over some other wavelength ranges of interest and wherein the multilayer stack of thin films acts as a barrier for certain gas-and liquid-phase analytes; embedding a patterned low-adhesion surface or layer between at least two layers within the multilayer stack of thin films; forming at least one evacuated or partially evacuated, enclosed optical cavity within the multilayer stack of thin films by causing delamination and buckling to occur in the regions of the patterned low-adhesion surface or layer, and wherein the buckled portion of the multilayer stack of thin films functions as a flexible membrane and mechanical resonator; and forming at least one partially enclosed optical cavity within the multilayer stack of thin films by causing delamination and buckling to occur in the regions of the patterned low-adhesion surface or layer, and wherein the buckled portion of the multilayer stack of thin films functions as a flexible membrane and mechanical resonator wherein said partially enclosed optical cavity is in fluid communication with the environment adjacent to said buckled portion. In one embodiment the optical resonance properties of the cavity are adjusted by altering the in-plane strain of the buckled portion of the multilayer. In a further embodiment changes in the in-plane strain are induced by selective absorption of light within one or more layers. In a further embodiment changes in the in-plane strain are induced by direct heating or cooling, such as by passing current through resistive heater electrodes. In a further embodiment changes in the in-plane strain are induced by applying voltage or current to one or more piezo-electric layers.

In one embodiment the low adhesion surface or layer is a fluorocarbon layer. In an alternative embodiment the low adhesion surface or layer is a self-assembled monolayer. In another embodiment delamination and buckling occur spontaneously upon deposition of the multilayer stack of thin layers. In another embodiment delamination and buckling occur through the application of mechanical vibrational energy. In another embodiment delamination and buckling occur through the introduction of a thermal cycling process. In another embodiment circular patterns are created in the low-adhesion surface or layer, such that half-symmetric or plano-concave optical resonant cavities are formed. In another embodiment temporal modulation of the in-plane strain of the buckled portion of the multilayer induces a vibrational mechanical oscillation.

In another aspect, the present invention provides for a device for detecting dynamic pressure changes in a fluid, including acoustic and ultrasound pressure changes, comprising a multiplicity of laminar thin films in which at least one of said multiplicity of laminar thin films has a patterned low adhesion surface between itself and an adjacent thin film; the multiplicity of laminar thin films selected so as to provide high optical reflectance over select wavelength ranges while being transparent to other wavelength ranges; the multiplicity of thin films act as a barrier to adjacent fluids; and an evacuated or partially evacuated, enclosed optical cavity created by delamination of at least one layer of said multilayer stack of thin film wherein the buckled portion of the multiplicity of laminar thin films results in an optically resonant cavity. In one embodiment the low adhesion layer is a fluorocarbon layer. In an alternative embodiment the low adhesion layer is a self-assembled monolayer.

In another aspect, the present invention provides for a device for generating dynamic pressure changes in a fluid, including acoustic and ultrasound pressure changes, comprising a multiplicity of laminar thin films in which at least one of said multiplicity of laminar thin films has a patterned low adhesion surface between itself and an adjacent thin film; the multiplicity of laminar thin films selected so as to provide high optical reflectance over select wavelength ranges while being transparent to other wavelength ranges; the multiplicity of thin films act as a barrier to adjacent fluids; an evacuated or partially evacuated, enclosed optical cavity created by delamination of at least one layer of said multilayer stack of thin film wherein the buckled portion of the multiplicity of laminar thin films results in an optically resonant cavity; and means for adjusting the in-plane strain of the buckled portion of the multiplicity of laminar thin films. In one embodiment the means of altering the in-plane strain of the buckled portion of the multiplicity of laminar thin films are resistive heater electrodes capable of receiving a current and in thermal communication with the buckled portion of the multiplicity of laminar thin films. In an alternative embodiments the means of altering the in-plane strain of the buckled portion of the multiplicity of laminar thin films are one or more piezo electric layers in mechanical communication with the buckled portion of the multiplicity of laminar thin films.

In another aspect, the present invention provides for a system for detecting dynamic pressure changes in a fluid comprising a device for generating dynamic pressure changes in a fluid, including acoustic and ultrasound pressure changes, the device comprising a multiplicity of laminar thin films in which at least one of said multiplicity of laminar thin films has a patterned low adhesion surface between itself and an adjacent thin film, the multiplicity of laminar thin films selected so as to provide high optical reflectance over select wavelength ranges while being transparent to other wavelength ranges, the multiplicity of thin films act as a barrier to adjacent fluids, an evacuated or partially evacuated, enclosed optical cavity created by delamination of at least one layer of said multilayer stack of thin film wherein the buckled portion of the multiplicity of laminar thin films results in an optically resonant cavity, and means for adjusting the in-plane strain of the buckled portion of the multiplicity of laminar thin films; an optical emitter capable of providing an optical signal to said enclosed optical cavity within the wavelength range to which the multiplicity of laminar thin films provide high optical reflectance; and an optical detector capable of detecting said optical signal within the wavelength range.

### BRIEF DESCRIPTION OF THE FIGURES

FIG. 1 shows a schematic of a system in which the devices of the present invention were tested;

FIG. 2 shows spectral scans observed using an exemplary Type B device of the present invention, at a series of fixed pressures;

FIG. 3 shows a plot of the peak wavelength of the fundamental mode resonance versus pressure for an exemplary Type B device of the present invention, at a series of fixed pressures;

FIG. 4 shows a plot of the fundamental resonance for an exemplary Type B device of the present invention when pressure is increased over a range of values;

FIG. 5 shows the change in peak wavelength at fixed pressures for an exemplary Type B device of the present invention;

FIG. 6 shows spectral scans observed using an exemplary Type A device of the present invention, at a series of fixed pressures;

FIG. 7 shows a plot of the peak wavelength of the fundamental mode resonance versus pressure for an exemplary Type A device of the present invention, at a series of fixed pressures;

FIG. 8 shows a vibrational spectrum for an exemplary Type B (a) and Type A (b) devices of the present invention with the fundamental resonance mode indicated;

FIG. 9 shows plots of predicted pressure response versus acoustic frequency, according to the single-harmonic oscillator model described herein, for Type A (a) and Type B (b) devices of the present invention;

FIG. 10 shows a schematic illustration of acoustic (ultrasonic) signals by a buckled dome element comprising part of the devices of the present invention by way of (a) piezo-electric or resistive heater elements or (b) applying a time-varying optical signal;

FIG. 11 shows (a) a simple first-order thermal model for the buckled dome elements comprising part of the devices of the present invention and (b) an illustration of a strategy for engineering the thermal time constant by addition of a thermally conductive layer;

FIG. 12 shows a schematic of a monolithic ultrasound transducer in accordance with the present invention;

FIG. 13 shows an illustration of a system for ultrasound detection using devices of the present invention;

FIG. 14 shows FFT traces for various conditions using the system depicted in FIG. 13;

FIG. 15 shows water coupled ultrasound pulses (a,b) and the corresponding frequency-domain responses (c,d) for Type A (a,c) and Type B (b,d) devices of the present invention;

FIG. 16 shows air coupled ultrasound pulses (a,b) and the corresponding frequency-domain responses (c,d) for Type A (a,c) and Type B (b,d) devices of the present invention; and

FIG. 17 shows the estimated NEP in air, for (a) Type A devices up to 5 MHZ, and (b) Type B devices up to 2 MHz.

### DETAILED DESCRIPTION OF THE PRESENT INVENTION

U.S. Pat. No. 8,503,849 discloses using the delamination between light guiding layers as a means to provide for substantially linear waveguides within a laminated structure. The present invention provides the novel finding that the delamination, limited to a defined and constrained region within a laminar structure, which is further defined by an elastomeric boundary which itself is opposed by a light reflective surface, may act as a pressure sensor in accordance with the method and systems of the present invention, providing novel and unexpected benefits as further described herein.

The present invention provides for pressure sensing with on-chip buckled-dome microcavities, whose novel properties address many of the shortcomings of conventional DEFPI devices. By way of non-limiting example, these cavities are manufactured in a completely monolithic process which can yield high-density arrays on a single chip. Additionally, the process produces inherently sealed cavities with an upper curved mirror of thickness on the order of ˜1-2 μm. Additionally, the cavities support high-quality and stable Laguerre-Gaussian modes, naturally suited to coupling by single-mode fibers and laser beams. Advantageously, the devices and methods of the present invention provide for an operating range and sensitivity for pressure sensing can be varied through the choice of the cavity dimensions, achieving sensitivities in the range ˜0.05-1 nm/kPa. The cavities also exhibit high finesse (>10³) and high vibrational resonance frequencies (>1 MHZ), which might make them useful for sensing of low-intensity and high-speed pressure phenomena.

Fabrication of buckled cavities is known in the art; wherein the cavities are fabricated by embedding circular patterns of a thin low-adhesion layer between two Bragg mirrors and subsequently inducing delamination buckles to form over these regions, driven by compressive stress in the upper Bragg mirror. The self-assembly nature of the process results in a highly predictable and smooth morphology, and the cavities tend to exhibit the ‘textbook’ Laguerre-Gaussian modes expected for a half- symmetric (plano-convex) spherical mirror cavity. The prior art has demonstrated cavities with base diameters ranging from ˜50 μm to several hundred um, and heights ranging from sub-um to several um.

The thermo-mechanical properties of dome cavities, including first-order treatments of the vibrational resonance frequencies of the buckled mirror and the temperature dependence of the resonant optical modes, have been previously analyzed and are known in the art (Bitarafan, M. et al. (2015) J Opt Soc Am, B32: 1214-1220). With the devices of the present invention, external pressure acts as a distributed force on the buckled mirror element, which modifies the height and shape of the domed cavity, and thereby modifies the optical spectrum in a manner that may be detected by means known in the art. Therefore changes in the cavity height result in a change in the optical properties of the cavity, or multiplicity of cavities, said changes in height induced primarily by changes in external pressure.

As non-limiting examples of the devices of the present invention, a set of domes with 50 um base diameter and 5.5-period a-Si/SiO₂ buckled mirrors, labeled as device Type “A” were used; as well as a set of domes with 100 μm base diameter and 4.5-period a-Si/SiO₂ buckled mirrors, labelled as device Type “B”. Nominally identical thin-film layers and layer thicknesses (quarter-wave layers at 1550 nm wavelength) are common to both samples. Specifically, nominal layer thicknesses are ˜105 nm and ˜265 nm for a-Si and SiO₂ layers, respectively, based on typical refractive indices (˜3.7 and ˜1.46 at 1550 nm wavelength) for the sputtered films.

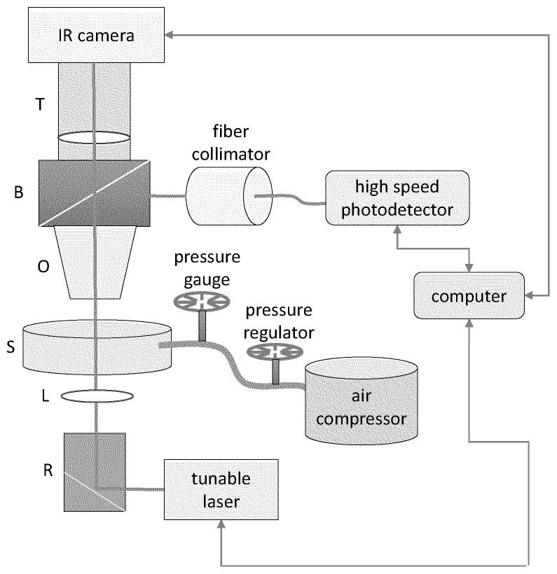

Devices of the present invention were placed inside a custom chamber as depicted in FIG. 1. The sealed enclosure was plumbed to an air compressor to enable pressurization, and the pressure is monitored by a digital gauge (Baker B50015 Digital Pressure Gauge); with all pressures described herein provided as relative to the lab pressure. The sample sits between input and output optical windows (High-Vacuum CF Flange Viewports for Ø1.5″ Windows) to enable optical transmission measurements. A tunable laser (Santec TSL-710) was coupled to a reflective collimator (Thorlabs RC-08) followed by a positive lens (KBX 058, f=75.00 mm), and coupled into the chamber through the input window. This resulted in a spot size ˜20 μm in diameter at the device plane. Light transmitted through the output window was collected by a long working distance objective lens (50x Mitutoyo Plan APO) and delivered to a near-infrared camera (Raptor Photonics Ninox 640 NX1.7-VS-CL-640). In addition to capturing mode-field images, the camera was also used as the detector in obtaining spectral scans, by summing the pixel intensity over the region of the image containing the low-order cavity modes. Some of the transmitted light was tapped off by a beam splitter and delivered to a high-speed photodetector (Resolved Instruments DPD80), to enable ‘tuned-to-slope’ measurements of the mechanical/vibrational spectra of the domes.

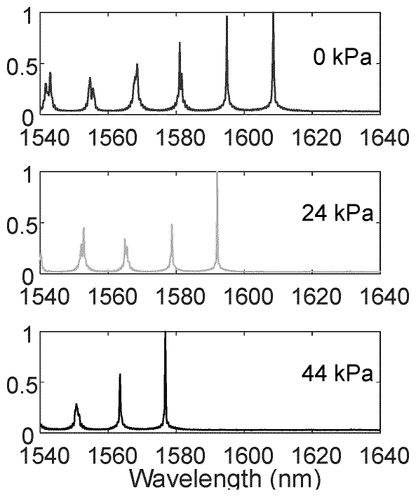

Typical pressure-induced changes in the optical transmission spectra for a Type B dome, with 100 μm base diameter, are shown by the series of plots in FIG. 2 at a series of three fixed pressures of 0 kPa, 24 kPa and 44 kPa. These Type B dome devices exhibit the characteristic resonance spectra of spherical mirror cavities, associated with stable Laguerre/Hermite-Gaussian (LG/HG) modes. The fundamental transverse mode (LG₀₀ₘ for a given longitudinal mode order m) is associated with the longest wavelength peak in the spectrum and the higher-order transverse modes produce a series of peaks moving towards shorter wavelengths. As the external pressure is increased, the cavity height is reduced and the resonance spectrum shifts towards shorter wavelengths. Notably the overall shape of the spectrum is relatively constant, with no significant change in ‘fringe contrast’ or linewidth.

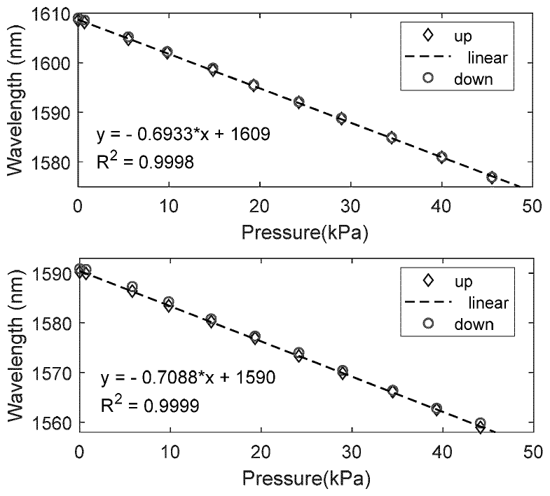

FIG. 3 shows plots of the fundamental resonance wavelength versus the pressure for two different Type B domes. These domes have a peak height of δ˜2.4 μm, and thus are operating in longitudinal mode order m=3 at λ˜1600 nm. Slight variations in height (and thus resonance wavelength) between domes of the same base diameter are typical for the process of manufacturing of the cavities. Both domes exhibit a nearly linear response with S₈₀˜0.7 nm/kPa, and relatively little hysteresis. The wavelength was measured at a series of increasing pressures, and then again as the system pressure was reduced back down. While there is some discrepancy between pressure-up and pressure-down data points in the low-pressure range, likely due to uncontrolled drifts in temperature and lab pressure over the relatively long interval between those particular measurements; correlation of pressure measurements was excellent.

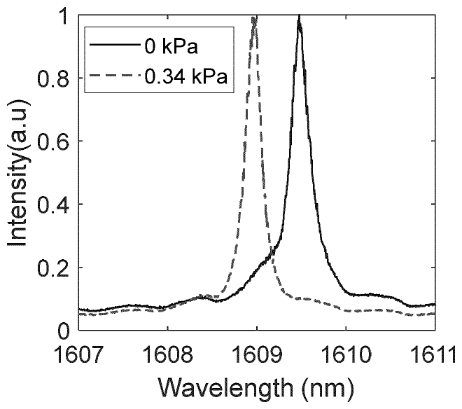

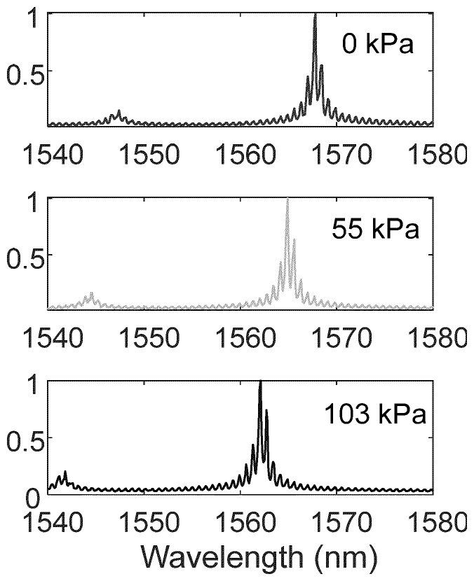

In addition to good linearity and repeatability (including low hysteresis) over a wide range of pressures, another desirable property of a pressure sensor is good resolution (i.e. that the minimum pressure change that can be reliably detected is as small as possible). In general, resolution correlates with the detection algorithm and the SNR of the detection system. FIG. 4 shows scans of the fundamental resonance taken at a relatively small step size (5 pm) setting of the tunable laser, and for the smallest increment in pressure (˜300 Pa) that could be reliably controlled in the described embodiment of the system. Note that the shift in wavelength is greater than the linewidth (δλ˜0.2 nm), so that detection of pressure changes much smaller than 300 Pa is possible assuming sufficiently high system SNR. Although not necessary to practice the present invention, it is believed that the periodic, low-amplitude ripple in the scans provided in FIG. 4, and more apparent in FIG. 6, are caused by substrate reflections, and devices incorporating appropriate anti-reflection coating are contemplated by the present invention to ameliorate this effect.

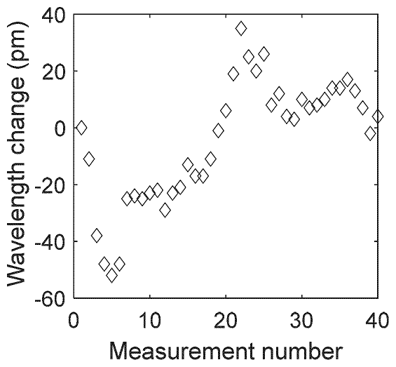

As a second way to assess the resolution, extraction of the peak wavelength over a relatively long period of time at a nominally fixed value of chamber pressure (0 kPa) was performed and provided in FIG. 5. As shown in FIG. 5, the time interval between each measurement was ˜5 minutes, with the horizontal axis spanning a total time >3 hours; revealing the presence of a relatively slow drift, likely attributable to variations in the laboratory temperature over the course of several hours. As known in the art, the ‘noise level’ can be characterized by the variations in peak wavelength over shorter intervals of the plot. Given the pressure response sensitivity S_{λ}˜1 nm/kPa, this would suggest the potential to resolve pressure changes on the order of 10 Pa with the devices of the present invention, subject to compensation for thermal drift by means known in the art or as further provided for herein.

FIG. 6 shows a series of spectral scans for the smaller and stiffer (Type A) domes, at 0 kPa, 55 kPa, and 103 kPa; with peak height δ˜0.8 μm and operating in longitudinal mode order m=1; revealing the same trends as discussed for Type B domes above. Substrate-reflection-induced ripple is much more noticeable in these scans; partly due to the poor mode matching between the input beam spot size (˜20 μm) and the fundamental mode spot size (˜5 μm diameter) for these cavities. The fundamental mode spot size for the larger (Type B) domes (˜10 μm diameter) is more closely matched to the input beam, although still not perfectly. The input beam spot size is determined by the long focal length lens required in this instance, in turn due to the long distance between the optical input window and the sample plane of the pressure chamber.

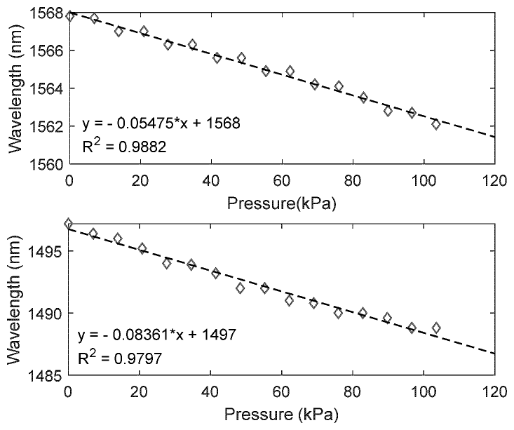

FIG. 7 provides a plot of the peak wavelength of the fundamental mode resonance versus pressure, overlaid by a linear fit of the data, for two different exemplary Type A domes. The fundamental resonance wavelength versus pressure for the dome from FIG. 6, as well as that for a second Type A dome, is plotted in FIG. 7. For both domes, the pressure response is approximately linear over the 0-103 kPa range, although deviations from linearity are more apparent than for the Type B domes above. This is attributed mainly to the parasitic ripple previously described, which impacts the identification of the resonance peak. While the pressure range studied was limited by the present experimental apparatus, it is contemplated that the approximately linear response extends to significantly higher pressures, given that the maximum height deflection. The maximum height deflection is derivable from the observations provided in FIG. 6 and FIG. 7, with reference to Equation 1;

$${S}_{λ 1} ≡ \frac{Δ λ}{Δ P} \approx \frac{2 \cdot {S}_{P}}{m} , \qquad Equation 1$$

Where S_{λ1} is the shift in peak wavelength of the fundamental cavity resonance, and m˜δ/(λ/2) is the longitudinal mode order of the cavity which provides for a maximum deflection of the reflective mirror of only a few nanometers (i.e. <1% of the starting height) at ˜103 kPa.

The Type A domes also showed somewhat higher variation in their pressure sensitivity, for example S_{λ}˜0.055 nm/kPa and S_{λ}˜0.083 nm/kPa for the representative cavities from FIG. 7. Slight variations in buckle height mentioned above, typical for the experimental fabrication process used herein, likely have a greater impact on the residual stress (and thus stiffness) of the buckled mirror for these smaller and shorter cavities. The ratio of experimental sensitivity for Type A and B domes (S_{λA}/S_{λB}˜0.1) is in very good agreement with the predictions of a simplified theoretical model.

It will be obvious to those skilled in the art that the results for the exemplary devices of the present invention show that within limits of elastic buckling, and for buckle heights exceeding the minimum value needed to support resonant optical modes at the probe wavelength of interest, that there is scope to design cavities to provide either higher sensitivity or higher operating range. Deposition of low-stress, half-wave (i.e. optically ‘vanishing’) capping layers on top of existing cavities (i.e. post-buckling), represent one means known in the art to increase the stiffness (and thus operating range) for a particular type of cavity.

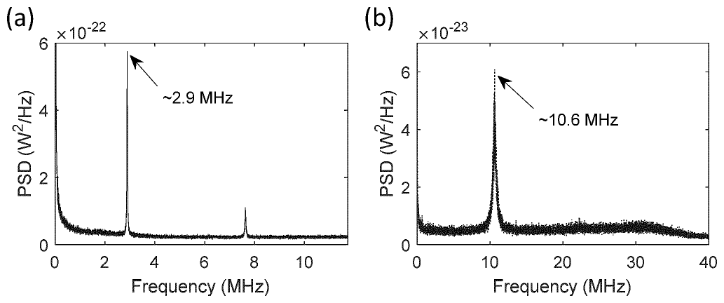

The mechanical/vibrational resonance spectra of exemplary devices of the present invention were measured using a tuned-to-slope technique as known in the art (Bitarafan, M. et al. (2015) J Opt Soc Am, B32: 1214-1220, Hornig, G. et al, (2020) Opt Express, 28:28113-28125). In brief, the laser is tuned to a wavelength just slightly removed from the fundamental cavity resonance (i.e. somewhere near the half-maximum transmission point of the Lorentzian cavity line-shape), such that vibrational motions of the upper mirror are translated to changes in cavity transmission. The thermal vibrational frequency spectrum of the buckled mirror can thus be extracted from a Fourier transform of the time-varying intensity signal recorded by a high-speed photodetector receiver. Typical results for Type B and Type A cavities are shown in FIG. 8a and FIG. 8b, respectively, with the lower SNR for the measurement of the Type A cavity due to the relatively poor input coupling efficiency. The fundamental vibrational frequencies, at ˜2.9 MHz for the type B cavity and at ˜10.6 MHz for the Type A cavity, are in good agreement with the first-order predictions. The high vibrational frequencies support the utility of devices of the present invention for sensing high frequency dynamic pressure changes, for example those associated with ultrasound waves generated as part of a signaling or as part of photoacoustic imaging.

To further characterize the utility of the devices of the present invention in ultrasound detection, theoretical consideration of the devices using a single-harmonic oscillator model was performed, wherein the frequency-dependent, pressure-induced motion of the buckled mirror within the devices of the present invention can be approximated by way of Equation 2.

$${σ}_{P} ( f ) = \frac{{a}^{2}}{4 π \cdot {m}_{eff} \cdot {[ {( {f}^{2} - {f}_{0}^{2} )}^{2} + {( f \cdot {f}_{0} / Q )}^{2} ]}^{1 / 2}} . \qquad Equation 2$$

Here, σ_{P} is the induced motion in units of [m/Pa], a is the base radius of the buckled dome, and m_{eff}, f₀, and Q are the effective mass, vibrational resonance frequency, and quality factor of the mechanical oscillator, respectively. Furthermore, f₀=(K_{eff}/M_{eff})^{1/2}/2π, where k_{eff} is the effective spring constant of the buckled mirror

This theoretical model was applied to two exemplary devices of the present invention, being the Type A with a 50 μm base diameter and Type B with a 100 μm base diameter, and for operation in both air and water as the external medium. For operation in air, a value of Q equal to 100 was used, which is a typical value used in the art (Bitarafan, M. et al. (2015) J Opt Soc Am B32: 1214-1220), and m_{eff}=0.3·mB, as is typical for the fundamental vibrational mode of a circular plate with mass m_{B}. For a micro-scale plate vibrating in water, the mechanical properties are modified by interactions with the fluid: first, there is an increase in the effective mass (i.e. the ‘added mass effect’) which causes a reduction in the mechanical resonant frequency; f_{0W}=f₀/(1+β), where f_{0W} is the resonant frequency in water. Furthermore, β≈0.6689·(ρ_{W}·a)/(ρ_{P}·h) , where ρ_{W} and ρ_{P} are the mass densities of water and the plate medium, respectively, and a and h are the radius and thickness of the plate, respectively. For plate dimensions relevant to the buckled domes within the devices of the present invention, the mechanical quality factor is reduced primarily through acoustic radiation into the water medium and can be approximated by Equation 3, where v_{W} is the sound velocity in water.

$${Q}_{W} \approx \frac{9 \cdot {ρ}_{P} \cdot ( 1 + β ) \cdot h \cdot {v}_{W}}{5 π \cdot {ρ}_{W} \cdot {f}_{0 W} \cdot {a}^{2}} . \qquad Equation 3$$

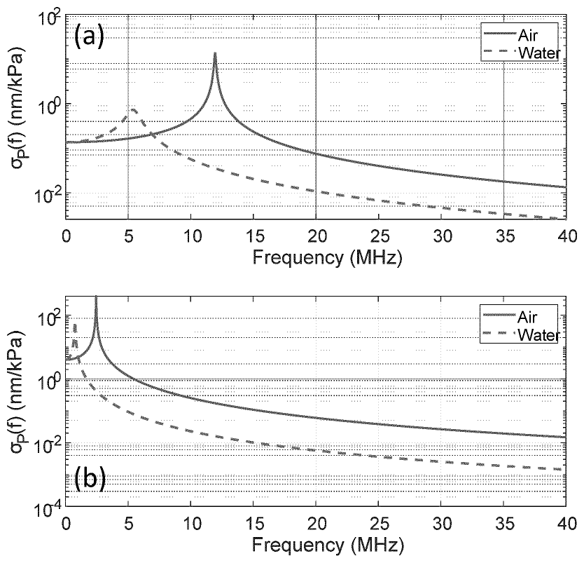

Using these first-order models, the predicted frequency-dependent pressure responses of the Type A and Type B domes within the exemplary devices, in both air and water, are plotted in FIG. 9. As expected, a peak response at the mechanical resonance frequency is predicted in each case. The zero-frequency intercepts are in agreement with the static pressure sensitivities described herein, while the response at the resonant frequency is enhanced by the mechanical Q-factor. The theoretical model described herein supports the exemplary devices of the present invention having significant response extending into the MHz frequency range, with the smaller Type A devices having a slightly lower response but also more gradual roll-off at higher frequencies. Extension from the theoretical modelling to the observations of the physical devices of the present invention, as described herein, higher-order mechanical resonant modes are present providing additional enhancement of the response at frequencies above the fundamental resonance.

For an optomechanical sensor, sensitivity is often limited only by laser shot noise and mechanical thermal noise (i.e. the natural vibrations of the mechanical element due to Brownian thermal noise). For reasonably high optical powers, the fundamental limit is set by the mechanical (displacement) thermal noise, which for a simple harmonic oscillator can be expressed (in units of m²/Hz) by way of Equation 4

$${S}_{xx} = \frac{{k}_{B} {Tf}_{0}}{2 {π}^{3} \cdot {m}_{eff} \cdot Q \cdot [ {( f - {f}_{0} )}^{2} + {( f \cdot {f}_{0} / Q )}^{2} ]} . \qquad Equation 4$$

It follows that the displacement-noise-limited NEP for an optomechanical sensor is frequency-independent (within the limits of the harmonic oscillator model). For buckled domes forming part of the devices of the present invention, by combining Equation 2 and Equation 4, new solution represented by Equation 5 arises, where NEP_{TD} indicates noise-equivalent pressure in the thermal displacement noise limit.

$${NEP}_{TD} = \frac{\sqrt{{S}_{xx}}}{{σ}_{P}} = \sqrt{\frac{2 {k}_{B} T \cdot {k}_{eff}}{{π}^{3} \cdot {a}^{4} \cdot {f}_{0} \cdot Q}} \qquad Equation 5$$

Table 1 gives projected sensitivity limits in both air and water, for the two exemplary devices of the present invention disclosed herein.

TABLE 1
Assumed and Predicted Parameters for Cavities
in Exemplary Devices of the Present Invention

| | Type A | | Type B | |
|---|---|---|---|---|
| Base radius, a | 25 | [μm] | 50 | [μm] |
| Mirror thickness, h | 1.95 | [μm] | 1.59 | [μm] |
| Mirror mass, m_{B} | 8.6 | [ng] | 28 | [ng] |
| Resonance freq. in air, f₀ | 10.9 | [MHz] | 2.7 | [MHz] |
| Resonance freq. in water, f₀ | 5.4 | [MHz] | 0.8 | [MHz] |
| Mechanical Q in air, Q_{A} | 160 | | 110 | |
| Mechanical Q in water, Q_{W} | 10 | | 17 | |
| DC pressure response, σ_{P} | 0.04 | [nm/kPa] | 1 | [nm/kPa] |
| Spring constant, K_{eff} | 4.9 × 10⁴ | [N/m] | 7.9 × 10³ | [N/m] |
| NEP_{TD} in air, NEP_{TD, A} | 135 | [μPa/Hz^{1/2}] | 33 | [μPa/Hz^{1/2}] |
| NEP_{TD} in water, NEP_{TD, W} | 780 | [μPa/Hz^{1/2}] | 155 | [μPa/Hz^{1/2}] |

The predicted NEP_{TD} values are amongst the lowest reported for optical ultrasound sensors and are well corroborated by experimental disclosed further herein. As known in the art; to achieve thermal-displacement-noise-limited sensitivity generally requires some combination of high optical Q, high mechanical Q, high coupling between the pressure wave and the mechanical mode, and/or a high optomechanical coupling coefficient (i.e., a high value of G=dω_{c}/dx, where ω_{c} is the cavity resonance frequency and x is the displacement of the mechanical part). Reliance on a high optical Q-factor necessitates relatively sophisticated locking of the interrogation laser to the cavity resonance, while reliance on a high mechanical Q-factor can create challenges with respect to linearity and dynamic range. Advantageously, the devices of the present invention achieve displacement-noise-limited sensitivity over a wide frequency range, despite their modest optical and mechanical Q-factors, in large part due to their highly efficient coupling between a pressure wave, the mechanical modes, and the optical mode of interest. For example, the ‘pressure participation ratio’ and ‘acousto-mechanical overlap factor’, (defined in Basiri-Esfahani, S. et al. (2019) Nat. Commun. 10, 132). are both very close to the ideal value of unity for the devices described herein. Moreover, G is large in the described herein, due to the direct correlation between mirror displacement and cavity resonance in a Fabry-Perot etalon.

This theoretical treatment shows that low NEP is favored by a low effective mass, a low spring constant, and a high mechanical quality factor. These are in some respects competing parameters; the larger type B devices achieve superior NEP_{TD} primarily due to their lower effective spring constant, which results in a pressure response that is approximately an order of magnitude higher compared to the type A devices. One skilled in the art will recognize that considerable scope exists for further reduction in NEP_{TD} and/or increase in the operational frequency range. By way of non-limiting example, by reducing the thickness of the buckled mirror, domes of smaller base diameter may be fabricated. Furthermore, additional thin film layers may be added after buckling, a strategy which can be used to stiffen a buckled mirror as well as to increase its reflectance. While buckling height is typically small for domes of very small base diameter given the laminar thin films comprising the devices of the present invention, it is possible to embed solid spacer layers on top of the bottom mirror, in order to achieve an optical resonance at some desired wavelength of operation (such as the 1550 nm wavelength region employed here). Thus, there is considerable scope for further optimization of the devices of the present invention, and it is contemplated that they are capable of achieving NEP_{TD} of less than 1 μPa/Hz^{1/2}, combined with an operational frequency range of greater than 20 MHz.

The unique combination of bandwidth, sensitivity, and omni-directionality of the devices of the present invention are anticipated to enable new applications for air-coupled ultrasound. Further, it is contemplated that the devices of the present invention are capable of detecting MHz-range ultrasound pulses at distances in air which would be considered in the art, as extreme; providing substantial advantages. The sensitivity of the devices of the present invention are contemplated as enabling high-frequency (i.e., high resolution) air-coupled imaging and inspection, with relaxed requirements on the proximity between the sensor and the sample. Moreover, these devices achieve NEPs in the MHz range comparable to the noise levels (a few μPa/Hz^{1/2}) associated with professional recording studios in the 0-20 KHz audio band. Moreover, since the devices have already been realized as dense on-chip arrays, they offer opportunity for spatially resolved ultrasound imaging, by way of non-limiting example, using a 2-D fiber array or a focused scanning beam configuration.

Buckled plates and shells offer unique options for actuation, because changes in the in-plane stress of the plate are coupled with changes in the out-of-plane deflection of the plate. For buckled cavities and waveguides such as those described herein, it has been previously established in the art that Δδ˜Δσ, where Δδ is a change in the peak height of the buckled structure and Δσ is a change in the biaxial compressive stress of the buckled structure (Bitarafan, M. et al. (2015) J Opt Soc Am B32: 1214-1220). By exploiting a mismatch in thermal expansion coefficients between the buckled structure and the substrate, for example, this enables thermal tuning of cavity resonance. Tuning and actuation can also be achieved using alternative (non-thermal) means of modulating the effective in-plane stress of the buckled mirror. For example, a piezo-electric thin film (e.g. a PZT or AIN film) can be deposited onto a buckled dome and patterned as a ring-shaped structure. This ensures that the piezo-electric material lies outside the central region of the dome where the low-order optical modes are located, and thus avoids degradation of the optical properties. Applying a voltage to the ring-shaped piezo-electric region thus modulates the in-plane stress and the height of the buckled dome.

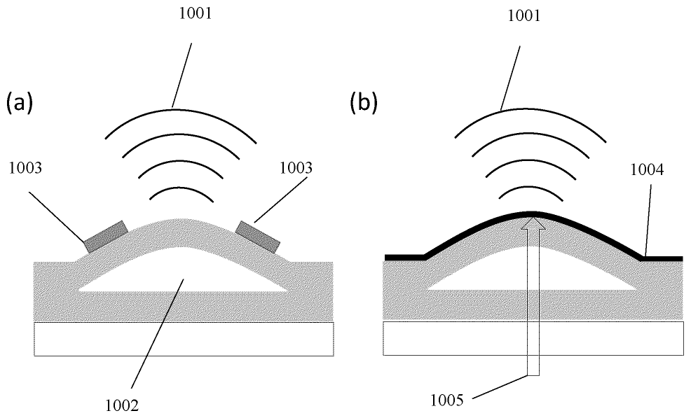

Therefore the present invention also contemplates the use of the buckled dome cavities to transmit ultrasound signals in this range. As shown in in FIG. 10, an electrical or optical signal is used to drive or actuate the mechanical vibrations of the buckled dome, which will then transmit acoustic waves into an external medium such as air or water. FIG. 10a shows a schematic illustration of the generation of acoustic (ultrasound) signals 1001 by a buckled dome cavity 1002, through electrical modulation of the in-plane stress of the buckled mirror. The in-plane stress is modulated by applying a time-varying voltage/current to piezo-electric or resistive heater contacts 1003. FIG. 10b shows a schematic illustration showing generation of acoustic signals as in FIG. 10a, except the in-plane stress of the buckled dome is modulated by applying a time-varying optical beam. An optically absorptive layer is embedded in the buckled mirror, so that time-varying optical signal by way of pulsed or modulated light induces a time-varying temperature change in the buckle, which in turn induces a time-varying out-of-plane deflection.

By way of non-limiting example, capacitive electrodes, as are often employed in conventional ultrasound transducers, may be added to the buckled dome cavities in order to drive such motion. However, those techniques typically require high-voltage electrical drive signals, especially for the relatively large spacing (˜1 μm) typical of the mirror separation in our buckled domes. Thus, techniques that exploit the coupling between in-plane strain and out-of-plane deflection discussed above are of interest. Both electrical and optical signals can be used to actuate or tune the buckled dome cavities, as illustrated in FIG. 10.

While electro-thermal or photo-thermal techniques can easily be used for slow tuning of the buckled domes, actuation at MHz frequencies requires careful engineering of the thermo-mechanical properties of the devices. Specifically, the heating/cooling time-constants associated with the buckled mirror need to be on the order of the temporal period at the target vibrational frequencies. This implies that thermal time constants should be in the sub-us range for actuation at MHz frequencies.

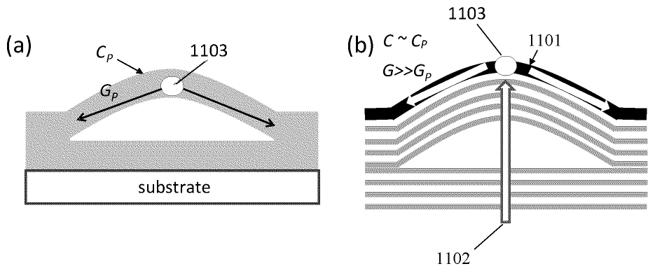

The essential details of the thermal analysis are depicted in FIG. 11(a), which illustrates that when thermal energy (heat) is deposited into the buckled mirrors of the devices of the present invention, the temperature of the buckled structure evolves (to first-order approximation) according to a thermal time constant τ=C_{P}/G, where C_{P} is the heat capacity of the buckled plate and G is a total thermal conductance between the buckled plate and its surroundings. For the conditions applicable for the devices of the present invention, wherein the gap between the buckled mirror and the substrate is evacuated, thermal conductance will be dominated by conduction through the material of the buckled structure and into the substrate (via the clamped boundaries of the buckle). In this case, G˜G_{P}˜5.8π·h·κ, where h and k are the thickness and (effective medium) thermal conductivity of the buckled mirror, respectively. Furthermore, the thermal time constant can be approximated τ˜(c_{ρ}⋅ρ/κ)·(a/2.4)², where a is the radius of the buckled dome, and c_{ρ} and ρ are the (effective medium) specific heat capacity and mass density of the buckled plate. For the buckled mirrors forming part of the devices of the present invention, this implies time constants in the tens to hundreds of microseconds range.

A strategy for engineering a faster and more efficient thermal response is depicted in FIG. 11b. While the specific example shown involves photo-thermal effects in an optically absorptive layer, a similar strategy could be employed by exploiting electro-thermal effect via resistive heater contacts. As shown in FIG. 11b, addition of a thin layer with high optical absorbance and high thermal conductivity 1101 can drastically alter the thermal dynamics of the buckled dome. For example, gold, copper or silver possess thermal conductivities which are several hundred times larger than the dielectric (e.g. a-Si, SiO₂, or Ta₂O₅) layers that comprise the buckled mirrors described herein. Other materials, such as graphene or diamond possess even higher thermal conductivities. Thus, a thin film of high thermal conductivity embedded within the buckled mirror can increase its effective thermal conductance by orders of magnitude while hardly changing its heat capacity. If the added layer is also designed to be optically absorptive at some wavelength of interest, a light signal 1102 which is non-resonant with the cavity modes can be used to tune or mechanically actuate the buckled dome, depositing heat within region 1103. Thus, thermal time constants (τ=C_{P}/G_{P}) well below 1 μs, enabling thermal actuation at tens of MHz, can be realized.

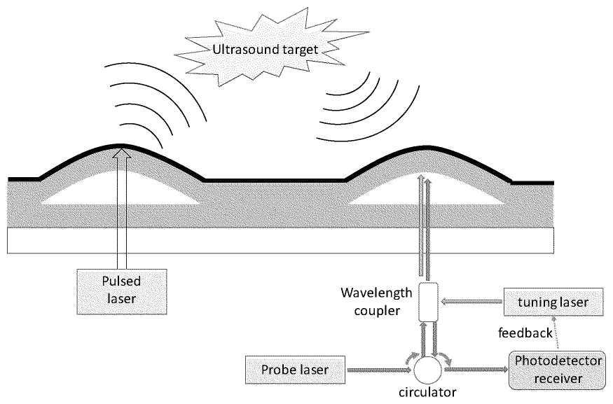

The methods and devices described herein can be used to implement an array of all-optical ultrasound transducers on a single probe unit, as shown by way of non-limiting example in FIG. 12. Such a probe unit could incorporate buckled dome elements designed for sensing acoustic (ultrasound) signals, and other buckled dome elements designed for generation of acoustic signals. While one buckled dome element designed for acoustic generation and another element designed for acoustic detection are depicted in FIG. 12, the present invention contemplates a probe unit device which incorporates a multiplicity of elements adapted for acoustic generation and acoustic detection in an array and in equal or unequal ratios. While an all-optical cavity tuning strategy is depicted in FIG. 12, the present invention contemplates replacement or augmentation of this with electrical tuning methods, as known in the art. Multiple acoustic sensing elements can be tuned into resonance with a single probe laser, through either electrical or optical means as described above. If optical tuning is employed, the tuning signal can be light of a different wavelength than the probe laser, chosen to be non-resonant with the cavity modes and in a transparency region of the optical mirrors. The tuning and probe light can be coupled to the cavity by using dichroic mirrors or fiber-optic based wavelength couplers. For example, wavelength couplers designed to efficiently combine 980 nm or 1480 nm wavelengths with 1550 nm-range wavelengths are widely available. For the ultrasound generation elements, pulsed lasers operating at MHz-range repetition rates are widely available or otherwise known in the art. Whether electrical or optical means are employed to tune the individual sensing domes, it is possible to use active feedback techniques to lock the cavity resonance to a position slightly detuned from the probe laser. This would enable the use of a single stabilized probe laser to interrogate a large array of the buckled dome sensors.

The novel devices of the present invention are particularly useful as sensing elements integrated directly in optical fiber arrays, providing particular utility as embedded sensors. Further, the novel devices of the present invention can be fabricated directly on the end of cleaved optical fibers. The opportunity for beneficial optical mode matching to single-mode fibers, thereby negating the need for supplementary optics such as packaged collimators, is one particular advantage of the devices described herein.

Given the capability to provide high-density of the devices of the present invention using the techniques of manufacturing of thin film devices disclosed herein, or otherwise known in the art; it is further possible to provide within the array of pressure sensor cavities, cavities of similar structure and physical characteristics, save for their being pressure insensitive; such pressure insensitivity arising from planned exposure of the inner cavity to the surrounding environment, by way of non-limiting example via an opening between the inner resonance cavity of the device and the surrounding environment. The signals from these pressure-insensitive devices may therefore provide both spacial and temporally relevant baselines, primarily associated with thermal effects on the devices; which may then be subtracted from the signals received from nearby pressure-sensitive devices of the present invention. This is contemplated to improve the resolution, sensitivity, and signal to noise ratio of multiplicities of pressure sensitive and pressure-insensitive devices of the present invention, as compared to one or more pressure-sensitive devices of the present invention.

The devices of present invention support stable, high-finesse cavity modes, thereby enabling employment of a range of simplified and high-accuracy detection algorithms, by way of non-limiting example peak-detection algorithms developed for Bragg grating sensors and as known in the art.

### Example 1: Ultrasound Detection in Water

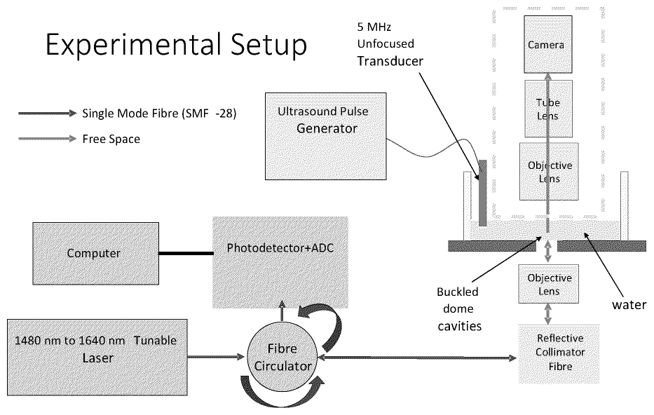

Using devices of the present invention, a system was constructed to detect ultrasound signals generated in an ambient water medium and a schematic provided as FIG. 13. A chip containing an array of buckled dome cavities was glued onto a circuit board, and aligned to a pre-drilled hole in order to accommodate optical access. A glass cylinder was then glued to the same board to serve as a fluid reservoir and mounted to a microscope setup as described below. A tunable laser (Santec TSL-710) was coupled into a cavity under test from beneath the sample (i.e.

through the silicon substrate). The laser wavelength was slightly detuned from the fundamental resonant wavelength of the cavity, so that vibrational motions of the buckled mirror are transduced into intensity variations in the light transmitted through and reflected from the cavity (i.e. the ‘tuned-to-slope technique’ known in the art). Light reflected from the cavity under test was delivered to a high-speed photodetector attached to a computer for analysis purposes.

The tunable laser was coupled to a reflective collimator (Thorlabs RC-08) followed by a positive lens (KBX 058, f=75.00 mm), and coupled into the chamber through the input window. This resulted in a spot size ˜20 μm in diameter at the device plane. Light transmitted through the output window was collected by a long working distance objective lens (50x Mitutoyo Plan APO) and delivered to a near-infrared camera (Raptor Photonics Ninox 640 NX1.7-VS-CL-640). In addition to capturing mode-field images, the camera was also used as the detector in obtaining spectral scans, by summing the pixel intensity over the region of the image containing the low-order cavity modes. Some of the transmitted light was tapped off by a beam splitter and delivered to a high-speed photodetector (Resolved Instruments DPD80), to enable ‘tuned-to-slope’ measurements of the mechanical/vibrational spectra of the domes.

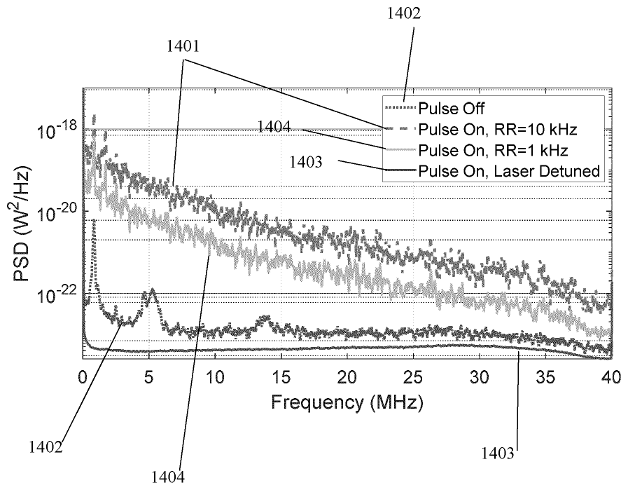

Ultrasound signals were introduced into the water reservoir using a 5 MHZ (center frequency) calibrated ultrasound transducer driven by a pulse generator (Olympus 5800). The results of an experiment using a typical type B dome are summarized in FIG. 14, which shows plots of the fast-Fourier-transformed (FFT) frequency spectrum of the time-varying light reflected from the cavity. With the laser completely detuned from the cavity resonance, the transduction mechanism is expected to be absent or very weak. This was confirmed by capturing FFT traces with the acoustic source on but with the laser detuned from resonance, revealing that the power spectral density (PSD) of the photodetector lies near the noise floor of the receiver in these cases (1403).

With the laser tuned near resonance (i.e. on the slope of the cavity Lorentzian transmission lineshape), any vibrational motion of the buckled mirror (i.e. due to thermal noise or driven by the ultrasound source) is expected to be imprinted as a time-varying light intensity. Curve 1402 in FIG. 14 shows the FFT spectrum extracted with the laser appropriately tuned and with the acoustic source off. This trace represents the PSD at the detector resulting from thermal vibrational (acousto-mechanical) noise of the buckled mirror element. A fundamental mechanical resonance frequency at ˜0.8 MHz was observed, in excellent agreement with the theoretical predictions for the type B dome in water. Signatures of higher-order vibrational modes are also present at higher frequency.

With the laser appropriately tuned and the introduction of an ultrasound signal, the FFT traces provide clear evidence for sensitive detection over the entire 0-40 MHZ range of the photodetector receiver used. As shown by curve 1404 and curve 1401 in FIG. 14, the PSD was obtained for two different repetition rates of the ultrasound source, and it lies ˜1-3 orders of magnitude above the thermo-mechanical noise floor over the entire range. Notably, these curves were not calibrated to account for the spectral response of the ultrasound source itself, which is centered at 5 MHz and delivers lower power extending into the higher frequency range. Nevertheless, these experiments confirm that the buckled dome microcavities elements of the present invention have potential to respond to ultrasound signals extending into the tens of MHz range.

In order to further investigate the sensitivity and SNR, a plastic cylinder was glued to the same substrate to serve as a holding tank, and then filled with high purity deionized (DI) water. The ultrasound transducers were placed directly overtop the device chip, at a distance corresponding to a 50 μs propagation delay in water (˜7 cm). Ultrasound pulses were then measured and analyzed with the transducers were driven by an arbitrary function generator to enable pulses of much lower energy.

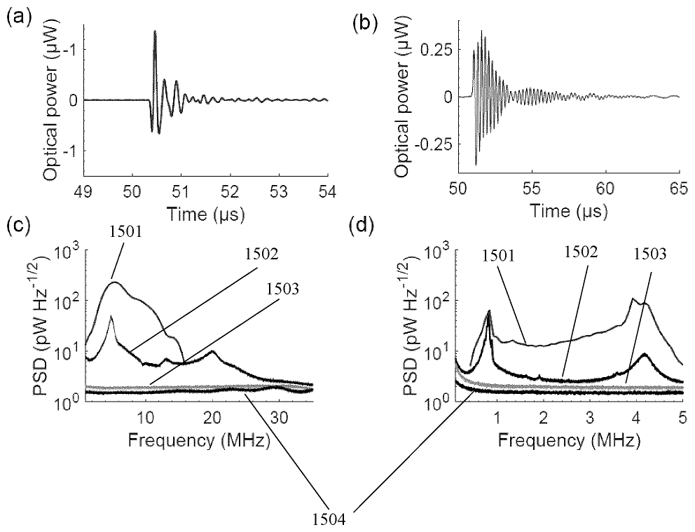

FIG. 15 shows a set of results for water-coupled ultrasound obtained using a 10 MHz transducer driven by a 100 mV (peak) electrical pulse with ultrasound pulses estimated to have peak-to-peak pressure of ˜300 Pa. The time-domain signals shown in FIG. 15a and FIG. 15c were averaged across 300 received pulses. From hydrophone measurements, the duration of the incident ultrasound pulse is on the order of a microsecond. The Type A devices reproduce this pulse characteristic reasonably well, although non-periodic oscillations persist beyond the ˜1 μs window, likely due to reverberations in the silicon substrate as discussed for the air case above. For the Type B devices, received pulses (even for larger distances or lower pulse energies) were clearly impacted by ‘ringing’ of the mechanical resonator, due in part to their higher response and the relatively high Q-factor of their fundamental resonance in water.

The frequency-domain content of these pulses was analyzed by performing a DFT on a windowed portion (˜49-51 μs) of the time-domain traces. The resulting signal spectra (1501) are plotted alongside the corresponding noise spectra (1502) in FIG. 15c and FIG. 15d, for device Type A and Type B, respectively. The signal trace for the Type A device clearly reflects the ˜1-16 MHz frequency content expected (from hydrophone calibrations) for the transducer used, with some resonant enhancement near 5 MHz. Consistent with the time-domain pulse, the signal spectrum for the Type B device is significantly impacted by the mechanical resonances.

These results, typical of measurements on devices of the present invention, demonstrate that a large separation between the background noise and the shot noise floor is observed over a large frequency range, extending from ˜0-30 MHz for the Type A devices. It is therefore contemplated that the devices of the present invention are capable of broadband sensing at the thermal-displacement noise limit. Second, while the reduction in mechanical resonance frequency and quality factor are consistent with the added mass and damping effects expected in water, asymmetric and multiple-peaked character of the resonant modes for these devices were consistently observed in water. This is hypothesized to represent thermal noise ‘crosstalk’ or ‘cross-coupling’, likely in the form of acoustic radiation into the water medium, between neighboring devices in the closely spaced cavity arrays. Cross-coupling between arrays of closely spaced and driven membranes is well-studied in ultrasound CMUT literature, however, crosstalk of thermal vibrational noise between neighboring non-driven devices has not been described previously and provides additional evidence for the advantageous extreme sensitivity and omni-directionality of the buckled domes as acoustic receivers.

### Example 2: Ultrasound Detection in Air

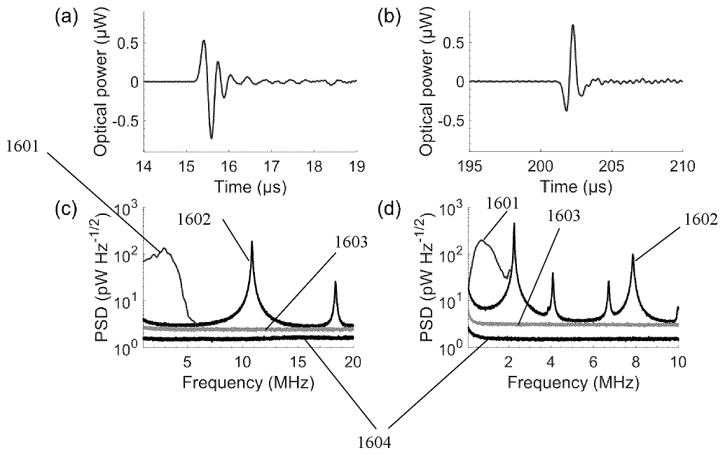

For demonstrating the detection of high-frequency ultrasound pulses delivered though an air medium, a 3.5 MHz commercially available ultrasound pulse generator (Olympus™ 5800PR) transducer driven with a high energy (100 μJ) electrical pulse. For the type A devices (FIG. 16a and FIG. 16c), the transducer-device spacing was set to ˜5 mm (i.e., ˜15 μs propagation delay), and the laser was adjusted near resonance and with ˜10 μW of average power received by the photodetector. A typical time-domain trace, with the photodetector triggered by the pulse generator, is shown in FIG. 16a. The corresponding frequency-domain content, shown as trace 1601 was obtained from the discrete Fourier transform (DFT) of the (300× averaged and bandpass filtered) pulse content lying between 14 μs and 16 μs. This signal response is plotted alongside the background thermo-mechanical noise spectrum (1602) extracted for the same cavity-laser detuning and laser power. This spectrum reveals the natural vibrational modes of the buckled mirror, with a fundamental resonance frequency at ˜11 MHz and a second-order resonance near ˜18 MHz. Also shown are the shot noise spectrum (1603), extracted from a signal trace with the laser detuned from the cavity resonance and with the same average optical power as above, and the spectrum of the photodetector dark noise (1604).

Analogous results are also shown for a type B device (FIG. 16b and FIG. 16d), but with the transducer-device spacing set to ˜7 cm (i.e., ˜200 μs propagation delay) in that case. The larger spacing provides preferential attenuation of the higher-frequency signal components, and thus reduced the ‘ringing’ caused by the overlap between the transducer's spectral content and the fundamental dome resonance at ˜2.4 MHZ. A typical time trace is shown in FIG. 16b, and the corresponding frequency-domain content is shown in FIG. 16d, where a window from 200 μs to 207 μs was used for the DFT in this case.

These results, typical of measurements on devices of the present invention, demonstrate that, with proper alignment to ensure good optical mode matching, a thermal-displacement-dominated noise floor was observed over a wide frequency range, and for relatively low optical powers (<<1 mW), which provides a significant advantage and advancement to the art. Further, this demonstrates the utility of devices of the present invention the devices for enabling high-SNR detection of ultrasound signals at frequencies well below their fundamental mechanical resonance. Moreover, since the frequency response is nearly flat in this regime, the received pulses are very similar to those recorded by a hydrophone. Non-periodic fluctuations beyond the duration of the main pulse, for example from 17 μs to 19 μs in

FIG. 16a, are consistent with reverberations in the underlying silicon substrate. These reverberations cause signal distortion such as the jagged features in the frequency-domain trace of FIG. 16c and could be mitigated by proper substrate mounting.

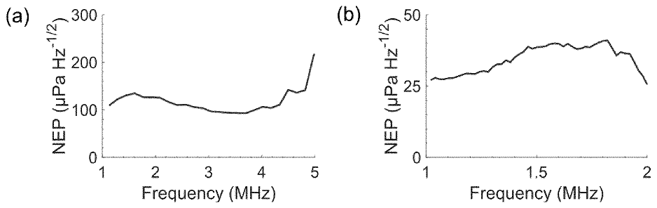

FIG. 17 shows representative plots of the extracted sensitivity for the devices. Air-coupled NEP as low as ˜100 and ˜30 μPa/Hz^{1/2} was estimated for device Type A (FIG. 17a) and Type B (FIG. 17b), respectively, in good agreement with the thermal-displacement-noise limited NEPs provided herein. The shaded bands in these plots represent an approximate range of uncertainty for NEP_{TD} from Equation 5, arising from the experimentally observed variations (over a large set of each type of device) in mechanical resonance frequency, quality factor, and effective spring constant. The excellent agreement between theory and experiment, as well as the relatively flat sensitivity profile, indicates that the devices are in fact operating near the mechanical-thermal noise limit. The measured sensitivity is predicted to extend to very low acoustic frequencies, and this is supported by the dominance of the thermal-displacement noise floor down to frequencies in the few kHz region (not shown), below which the electronic noise begins to dominate. The utility of the devices at sub-MHz frequencies was qualitatively verified including experiments at human audible frequencies <20 kHz, in which the devices were used to receive music signals and deliver them to an audio amplifier.

The small size of the devices is expected to result in a nearly omni-directional response at MHz frequencies. To assess this, the 3.5 MHz transducer was mounted on a rotational stage and measured the device response at various angles, and for fixed transducer-device spacing and energy of the driving pulse. An essentially non-directional response was verified in an angular range of approximately 60 degrees, and other observations suggest that this response extends to near-glancing angles.

While particular embodiments of the present invention have been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiments. The invention is therefore to be considered limited solely by the scope of the appended claims.

1. A method of forming a pressure sensitive optical resonant cavity and mechanical resonator comprising:
i. Forming a multilayer stack of thin films, wherein the multilayer stack of thin films provides high reflectance over some wavelength ranges of interest and is transparent over some other wavelength ranges of interest and wherein the multilayer stack of thin films acts as a barrier for fluids;
ii. Embedding a patterned low-adhesion surface or layer between at least two layers within the multilayer stack of thin films;
iii. Forming an evacuated or partially evacuated, enclosed optical cavity within the multilayer stack of thin films by causing delamination and buckling to occur in the regions of the patterned low-adhesion surface or layer; and
iv. wherein the buckled portion of the multilayer stack of thin films functions as a flexible membrane and mechanical resonator.

2. The method of claim 1 wherein the optical resonance properties of the cavity are adjusted by altering the in-plane strain of the buckled portion of the multilayer.

3. The method of claim 2 wherein changes in the in-plane strain are induced by selective absorption of light within one or more layers

4. The method of claim 2 wherein changes in the in-plane strain are induced by direct heating or cooling, such as by passing current through resistive heater electrodes.

5. The method of claim 2 wherein changes in the in-plane strain are induced by applying voltage or current to one or more piezo-electric layers.

6. The method of claim 1 in which the low adhesion surface or layer is a fluorocarbon layer.

7. The method of claim 1 in which the low adhesion surface or layer is a self- assembled monolayer.

8. The method of claim 1 in which delamination and buckling occur spontaneously upon deposition of the multilayer stack of thin layers.

9. The method of claim 1 in which delamination and buckling occur through the application of mechanical vibrational energy.

10. The method of claim 1 in which delamination and buckling occur through the introduction of a thermal cycling process.

11. The method of claim 1 in which circular patterns are created in the low-adhesion surface or layer, such that half-symmetric or plano-concave optical resonant cavities are formed.

12. The method of claim 1 wherein a temporal modulation of the in-plane strain of the buckled portion of the multilayer induces a vibrational mechanical oscillation.

13. A method for forming a multiplicity of sealed and non-sealed cavity optomechanical devices on a single wafer, comprising:
i. Forming a multilayer stack of thin films, wherein the multilayer stack of thin films provides high reflectance over some wavelength ranges of interest and is transparent over some other wavelength ranges of interest and wherein the multilayer stack of thin films acts as a barrier for certain gas- and liquid-phase analytes;
ii. Embedding a patterned low-adhesion surface or layer between at least two layers within the multilayer stack of thin films;
iii. Forming at least one evacuated or partially evacuated, enclosed optical cavity within the multilayer stack of thin films by causing delamination and buckling to occur in the regions of the patterned low-adhesion surface or layer, and wherein the buckled portion of the multilayer stack of thin films functions as a flexible membrane and mechanical resonator; and
iv. Forming at least one partially enclosed optical cavity within the multilayer stack of thin films by causing delamination and buckling to occur in the regions of the patterned low-adhesion surface or layer, and wherein the buckled portion of the multilayer stack of thin films functions as a flexible membrane and mechanical resonator wherein said partially enclosed optical cavity is in fluid communication with the environment adjacent to said buckled portion.

14. The method of claim 13 wherein the optical resonance properties of the cavity are adjusted by altering the in-plane strain of the buckled portion of the multilayer.

15. The method of claim 14 wherein changes in the in-plane strain are induced by selective absorption of light within one or more layers

16. The method of claim 14 wherein changes in the in-plane strain are induced by direct heating or cooling, such as by passing current through resistive heater electrodes.

17. The method of claim 14 wherein changes in the in-plane strain are induced by applying voltage or current to one or more piezo-electric layers.

18. The method of claim 13 in which the low adhesion surface or layer is a fluorocarbon layer.

19. The method of claim 13 in which the low adhesion surface or layer is a self-assembled monolayer.

20. The method of claim 13 in which delamination and buckling occur spontaneously upon deposition of the multilayer stack of thin layers.

21. The method of claim 13 in which delamination and buckling occur through the application of mechanical vibrational energy.

22. The method of claim 13 in which delamination and buckling occur through the introduction of a thermal cycling process.

23. The method of claim 13 in which circular patterns are created in the low-adhesion surface or layer, such that half-symmetric or plano-concave optical resonant cavities are formed.

24. The method of claim 13 wherein a temporal modulation of the in-plane strain of the buckled portion of the multilayer induces a vibrational mechanical oscillation.

25. A device for detecting dynamic pressure changes in a fluid, including acoustic and ultrasound pressure changes, comprising
a. A multiplicity of laminar thin films in which at least one of said multiplicity of laminar thin films has a patterned low adhesion surface between itself and an adjacent thin film;
b. The multiplicity of laminar thin films selected so as to provide high optical reflectance over select wavelength ranges while being transparent to other wavelength ranges;
c. The multiplicity of thin films act as a barrier to adjacent fluids; and
d. an evacuated or partially evacuated, enclosed optical cavity created by delamination of at least one layer of said multilayer stack of thin film wherein the buckled portion of the multiplicity of laminar thin films results in an optically resonant cavity.

26. The device of claim 25 in which the low adhesion layer is a fluorocarbon layer.

27. The device of claim 25 in which the low adhesion layer is a self-assembled monolayer.

28. A device for generating dynamic pressure changes in a fluid, including acoustic and ultrasound pressure changes, comprising
a. A multiplicity of laminar thin films in which at least one of said multiplicity of laminar thin films has a patterned low adhesion surface between itself and an adjacent thin film;
b. The multiplicity of laminar thin films selected so as to provide high optical reflectance over select wavelength ranges while being transparent to other wavelength ranges;
c. The multiplicity of thin films act as a barrier to adjacent fluids;
d. an evacuated or partially evacuated, enclosed optical cavity created by delamination of at least one layer of said multilayer stack of thin film wherein the buckled portion of the multiplicity of laminar thin films results in an optically resonant cavity; and
e. means for adjusting the in-plane strain of the buckled portion of the multiplicity of laminar thin films.

29. The device of claim 28 wherein means of altering the in-plane strain of the buckled portion of the multiplicity of laminar thin films are resistive heater electrodes capable of receiving a current and in thermal communication with the buckled portion of the multiplicity of laminar thin films.

30. The device of claim 28 wherein means of altering the in-plane strain of the buckled portion of the multiplicity of laminar thin films are one or more piezo electric layers in mechanical communication with the buckled portion of the multiplicity of laminar thin films.

31. A system for detecting dynamic pressure changes in a fluid comprising;
a. A device for generating dynamic pressure changes in a fluid, including acoustic and ultrasound pressure changes, the comprising
i. A multiplicity of laminar thin films in which at least one of said multiplicity of laminar thin films has a patterned low adhesion surface between itself and an adjacent thin film;
ii. The multiplicity of laminar thin films selected so as to provide high optical reflectance over select wavelength ranges while being transparent to other wavelength ranges;
iii. The multiplicity of thin films act as a barrier to adjacent fluids;
iv. an evacuated or partially evacuated, enclosed optical cavity created by delamination of at least one layer of said multilayer stack of thin film wherein the buckled portion of the multiplicity of laminar thin films results in an optically resonant cavity; and
v. means for adjusting the in-plane strain of the buckled portion of the multiplicity of laminar thin films.
b. an optical emitter capable of providing an optical signal to said enclosed optical cavity within the wavelength range to which the multiplicity of laminar thin films provide high optical reflectance; and
c. an optical detector capable of detecting said optical signal within the wavelength range.

32. The system of claim 31, wherein the fluid is air and the dynamic pressure changes in said fluid are high-frequency ultrasonic pressure signals.
